(19) United States
(12) Patent Application Publication
(10) Pub. No.: US 2026/0170797 A1
(43) Pub. Date: Jun. 18, 2026

(54) METHOD AND APPARATUS FOR GENERATING TRAINING DATA

(71) Applicants: HYUNDAI MOTOR COMPANY, Seoul (KR); KIA CORPORATION, Seoul (KR)

(72) Inventor: Eunseok Jeon, Hwaseong-si (KR)

(73) Assignees: HYUNDAI MOTOR COMPANY, Seoul (KR); KIA CORPORATION, Seoul (KR)

(21) Appl. No.: 19/402,378

(22) Filed: Nov. 26, 2025

(30) Foreign Application Priority Data
Dec. 17, 2024 (KR) 10-2024-0188546

(51) Int. Cl. G06V 10/75; G01S 17/89; G06V 10/25; G06V 10/34; G06V 10/74; G06V 10/774

(52) U.S. Cl. CPC G06V 10/757; G01S 17/89; G06V 10/25; G06V 10/34; G06V 10/761; G06V 10/774

(57) ABSTRACT

A method and an apparatus for recognizing a distant object from image and point data are provided. A method of generating training data includes: receiving image data and point data through a camera sensor and a light detection and ranging (LiDAR) sensor; determining a vanishing point in the image data; generating object information of a first object located adjacent to the vanishing point; generating object information of a second object identified in the point data; matching the first object with the second object; and labeling the object information in the image data. The first object is present in partial image data designated as a predetermined distance range from the vanishing point. Generating the object information of the first object located adjacent to the vanishing point includes the object information of the first object in a state in which the partial image data is upscaled.

### CROSS-REFERENCE TO RELATED APPLICATION

This application claims the priority to and benefit of Korean Patent Application No. 10-2024-0188546, filed on Dec. 17, 2024, the entire disclosure of which is incorporated herein by reference.

### TECHNICAL FIELD

The present disclosure relates to techniques for recognizing and labeling an object using a sensor.

### BACKGROUND

In recent years, technologies for controlling vehicle driving through autonomous driving or vehicle assistance functions have been introduced.

Vehicles with autonomous driving or vehicle assistance functions may recognize objects around the vehicles and may perform control with regard to the objects. Vehicles are equipped with various sensors to recognize nearby objects. In particular, sensors mainly used for object recognition in vehicles include camera sensors, light detection and ranging (LiDAR) sensors, and radar sensors.

When the above-described sensors recognize object information, it is difficult to recognize objects located at a distance due to the image quality and resolution of the sensors and the frequency of collected data. Therefore, there is a need for a technology for easily identifying objects located at a distance from data collected through each sensor and generating location information of the objects. The subject matter described in this background section is intended to promote an understanding of the background of the disclosure and thus may include subject matter that is not already known to those of ordinary skill in the art.

### SUMMARY

The present disclosure is directed to recognizing an object located at a distance from data collected through a camera sensor and a light detection and ranging (LiDAR) sensor.

The technical objectives of the present disclosure are not limited to the above. Other objectives that are not described above should be clearly understood by those having ordinary skill in the art from the detailed description below.

According to an aspect of the present disclosure, a method of generating training data includes receiving image data and point data through a camera sensor and a light detection and ranging (LiDAR) sensor. The method further includes identifying a vanishing point from the image data. The method further includes generating object information of a first object located adjacent to the vanishing point. The method further includes generating object information of a second object identified from the point data. The method further includes matching the first object with the second object. The method further includes labeling the object information in the image data.

The first object may be present in partial image data designated as a predetermined distance range from the vanishing point. Generating the object information of the first object located adjacent to the vanishing point includes generating the object information of the first object in a state in which the partial image data is upscaled.

Identifying the vanishing point in the image data may include identifying the vanishing point as a point at which extension lines of straight-line shaped objects recognized in the image data intersect.

A straight-line shaped object of the straight-line shaped objects may include at least one of a lane, a median strip, a building, or a vehicle.

The object information of the first object may include a first bounding box including three-dimensional (3D) position information of the first object, and the object information of the second object may include a second bounding box including 3D position information of the second object.

The first bounding box may include position information adjusted inversely proportional to an upscaling ratio.

The second bounding box may include a candidate box generated to include at least some of points located at a distance in the point data.

The method may further include matching the first bounding box and the second bounding box in a view having a predetermined viewpoint.

Matching the first object and the second object may include designating a first matching box from the first bounding box based on a distance and a morphological similarity with the second bounding box. Matching the first object and the second object may further include adjusting a position of the first matching box based on the second bounding box. Matching the first object and the second object may further include designating a second matching box from candidate boxes based on a degree of overlap with the first matching box and the number of overlapping points with the first matching box. Matching the first object and the second object may further include determining that the first object included in the first matching box and the second object included in the second matching box are the same object.

Labeling the object information in the image data may include labeling 3D position information of the first matching box and the second matching box and pixel information of the first object in the image data.

The method may further include generating the 3D position information of the first object by reflecting extrinsic parameters of the camera sensor.

The view may include a viewpoint in a height direction of the first bounding box and the second bounding box.

Adjusting the position of the first matching box may include adjusting the position of the first matching box to a position at which points included in the second matching box are maximally included in the first matching box.

The method may further include, after determining whether the first object and the second object are identical, projecting a first matching box and a second matching box onto an image to determine consistency of the object information of the first object and the object information of the second object.

According to an aspect of the present disclosure, an apparatus for generating training data includes: a processor and a memory configured to store image data of a camera sensor and point data of a light detection and ranging (LiDAR) sensor.

The processor may include an image processing unit configured to generate object information of a first object from the image data. The processor may further include a point processing unit configured to generate object information of a second object from the point data. The processor may include a matching unit configured to match the object information of the first object and the object information of the second object.

The image processing unit may further identify a vanishing point from the image data, the first object may be present in partial image data designated as a predetermined distance range from the vanishing point. The image processing unit may further generate the object information of the first object in a state in which the partial image data is upscaled.

The image processing unit may further identify the vanishing point as a point at which extension lines of straight-line shaped objects recognized in the image data intersect.

A straight-line shaped object of the straight-line shaped objects may include at least one of a lane, a median strip, a building, or a vehicle.

The object information of the first object may include a first bounding box including three-dimensional position information of the first object, and the object information of the second object may include a second bounding box including three-dimensional position information of the second object.

The second bounding box may include a candidate box generated to include at least some of points located at a distance in the point data.

The matching unit may further match the first bounding box with the second bounding box in a view having a predetermined viewpoint.

The first bounding box may include position information adjusted inversely proportional to an upscaling ratio.

### BRIEF DESCRIPTION OF THE DRAWINGS

The above and other objects, features, and advantages of the present disclosure should become more apparent to those having ordinary skill in the art by describing embodiments thereof in detail with reference to the accompanying drawings, in which:

FIG. 1 is a diagram illustrating a vehicle transmitting and receiving data through communication with another device;

FIG. 2 is a diagram illustrating modules of a vehicle according to an embodiment of the present disclosure;

FIG. 3 is a diagram illustrating modules of a server according to another embodiment of the present disclosure;

FIG. 4 is a diagram illustrating an apparatus for generating training data according to an embodiment of the present disclosure;

FIG. 5 is a flowchart illustrating a method of generating training data according to an embodiment of the present disclosure;

FIG. 6 is a flowchart illustrating a vanishing point identification method according to an embodiment of the present disclosure;

FIG. 7 is a diagram illustrating a vanishing point identified in image data according to an embodiment of the present disclosure;

FIG. 8 is a flowchart illustrating a method of generating first object information according to an embodiment of the present disclosure;

FIGS. 9A and 9B are diagrams illustrating a portion of image data being upscaled according to an embodiment of the present disclosure;

FIG. 10 is a flowchart illustrating a method of generating second object information according to an embodiment of the present disclosure;

FIG. 11 is a diagram illustrating a second bounding box including a candidate box according to an embodiment of the present disclosure;

FIG. 12 is a flowchart illustrating a method of matching a first object with a second object according to an embodiment of the present disclosure; and

FIGS. 13A and 13B are drawings illustrating matching of a first matching box with a second matching box according to an embodiment of the present disclosure.

### DETAILED DESCRIPTION

Hereinafter, embodiments of the present disclosure are described in detail with reference to the attached drawings so that those having ordinary skill in the art can easily implement the present disclosure. However, the present disclosure may be implemented in various different forms and is not limited to the embodiments described herein.

In the description of the present disclosure, when it is determined that detailed description of related technology may unnecessarily obscure the gist of the present disclosure, the detailed description has been omitted. In addition, parts in the drawings that are not related to the description of the present disclosure have been omitted, and the same reference numerals are used to refer to the same or equivalent elements in the drawings.

In the present disclosure, it should be understood that when an element is referred to as being “connected” or “coupled” to another element, the element can be directly connected or coupled to the other element, or intervening elements may be present. It should be further understood that the terms “comprise,” “comprising,” “include” and/or “including” used herein specify the presence of stated features, integers, steps, operations, elements, and/or components. However, the terms do not preclude the presence or addition of one or more other features, integers, steps, operations, elements, components, and/or groups thereof.

In the present disclosure, the terms “first,” “second,” and the like are used only for the purpose of distinguishing one component from another component and do not limit the order or importance between the components unless specifically stated otherwise. Accordingly, within the scope of the present disclosure, a first component in one embodiment may be referred to as a second component in another embodiment. Similarly, a second component in one embodiment may be referred to as a first component in another embodiment.

In the present disclosure, the components that are distinguished from each other are intended to clearly explain the characteristics of each and do not necessarily mean that the components are separated. In other words, a plurality of components may be integrated to form a single hardware or software unit, or a single component may be distributed to form a plurality of hardware or software units. Accordingly, even if not mentioned separately, such integrated or distributed embodiments are also included in the scope of the present disclosure.

In the present disclosure, the components described in various embodiments are not necessarily essential components, and some may be optional components. Accordingly, an embodiment that includes a subset of the components described in one embodiment is also included in the scope of the present disclosure. In addition, an embodiment that includes other components in addition to the components described in various embodiments is also included in the scope of the present disclosure.

In the disclosure, a phrase such as “A or B,” “at least one of A and B,” “at least one of A or B,” “A, B, or C,” “at least one of A, B, and C,” and “at least one of A, B, or C” may include any one of the items listed together in the corresponding phrase, or any possible combination thereof.

The advantages and features of the present disclosure and ways of achieving them should become readily apparent with reference to the detailed description of the following embodiments in conjunction with the accompanying drawings. However, the present disclosure is not limited to such embodiments and may be embodied in various forms. The embodiments to be described below are provided only to complete the present disclosure of the present disclosure and assist those having ordinary skill in the art in fully understanding the scope of the present disclosure, and the scope of the present disclosure is defined only by the appended claims. When a controller, module, component, device, element, part, unit, or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

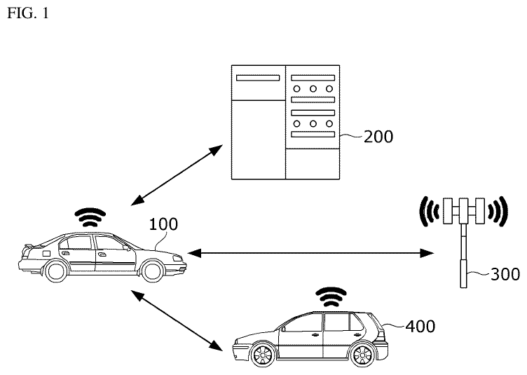

Hereinafter, a vehicle and a server used to acquire training data for a driving assistance model are described with reference to FIGS. 1, 2, and 3. The present disclosure describes an embodiment in which a vehicle 100 acquires sensor data that may be utilized as training data based on vehicle data from among sensor data, such as image data, acquired by sensors of the vehicle 100. The vehicle 100 transmits the sensor data to a server 200 that trains and distributes a driving assistance model with the training data. However, the above-described embodiment may also be applied to another embodiment in which the server 200 receives sensor data and vehicle data of the vehicle 100, selects sensor data that may be utilized as training data based on the vehicle data, and trains a driving assistance model using the selected sensor data.

FIG. 1 is a drawing illustrating a vehicle transmitting and receiving data by communicating with another device.

Referring to FIG. 1, the vehicle 100 may be driven based on electric energy or fossil energy. In the case of electric energy, the vehicle 100 may be, for example, a pure battery-based vehicle driven only by a high-voltage battery. In another example, a gas-based fuel cell may be used as an energy source for the vehicle 100. In addition, the fuel cell may utilize various forms of gas capable of generating electric energy, and the gas may be charged into the vehicle 100 in a liquefied state, for example. In this example, the gas may be hydrogen. However, it is not limited thereto, and various gases may be applied. In the case of fossil energy, the vehicle 100 is driven based on fuel such as gasoline, diesel, or liquefied gas and may be equipped with an internal combustion engine that drives an actuating unit 116 by combustion of the fuel. The engine may be included in an energy generating unit 110 that provides the driving rotational force of the wheel to a wheel driving unit 118. As another example, the vehicle 100 may selectively utilize the energy of a fossil energy-based internal combustion engine and an electric battery to drive the actuating unit 116, and such a vehicle may be a hybrid type vehicle.

The vehicle 100 may be a device capable of movement. The vehicle 100 may be a ground vehicle that travels on the ground and may be a typical passenger or commercial vehicle, a purpose-built vehicle (PBV), or the like. The vehicle 100 may be a four-wheeled vehicle, such as a passenger car, an SUV, or a small truck, or may be a vehicle with more than four wheels, such as a bus, a large truck, a container transport vehicle, a heavy equipment vehicle, or the like. The vehicle 100 may be a robot in a broad sense, such as a means of transportation, and the robot may be moved using wheels, tracks, or other moving modules.

The vehicle 100 may be controlled and driven autonomously, and autonomous driving may be implemented as semi-autonomous driving or fully autonomous driving. Fully autonomous driving may be provided as autonomous mobility in which a processor 122 of the vehicle 100 maintains complete control without user intervention even when the driving situation is uncertain. Semi-autonomous driving may be provided as autonomous mobility that requires driver intervention depending on a specific driving situation. Semi-autonomous driving may be implemented by allowing the user to perform manual driving by having the processor 122 deactivate autonomous driving when the above situation occurs and may transfer control to the user. According to the level of autonomous driving defined by the Society of Automotive Engineers (SAE), semi-autonomous driving corresponds to autonomous driving level 1 to level 4, and fully autonomous driving corresponds to level 5.

The vehicle 100 may communicate with other devices 200, 300 or another vehicle 400. The other devices may include, for example, a server 200 that supports various controls, status management, and driving of the vehicle 100, and/or an intelligent transportation system (ITS) device 300 for receiving information from an ITS, various types of user devices, and the like. The server 200 is, for example, an external device operated by a vehicle manufacturer or provided to service autonomous driving and may receive connected data of the vehicle 100 or transmit data necessary for autonomous driving. The server 200 may transmit various information and software modules used for controlling the vehicle 100 to the vehicle 100 in response to requests and data transmitted from the vehicle 100 and the user device to support autonomous driving of the vehicle 100 and various services.

The ITS device 300 is, for example, a roadside base station (road side unit, i.e., RSU), and the ITS device 300 may exchange vehicle recognition data, driving control and status data, environmental data around the vehicle, map data, and the like with the vehicle 100 through vehicle-to-infrastructure (V2I) technologies to assist the user with driving or support autonomous driving of the vehicle 100. The vehicle 100 may exchange the data listed above with another vehicle 400 through vehicle-to-vehicle (V2V) technologies to support manual driving or autonomous driving.

The vehicle 100 may perform communication with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, or a WAVE communication network for communication with the server 200, the ITS device 300, and other vehicles 400. As another example, DSRC or the like used in the vehicle 100 may also be used for communication between vehicles. The communication method between the vehicle 100, the server 200, the ITS device 300, other vehicles 400, and the user device is not limited to the above-described embodiment.

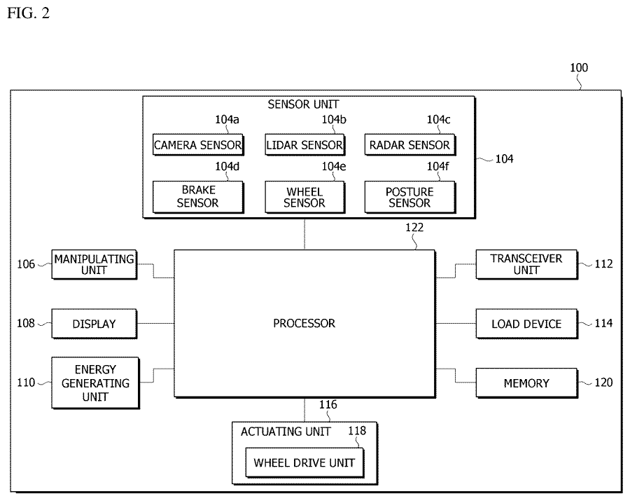

FIG. 2 is a drawing illustrating modules of a vehicle according to an embodiment of the present disclosure.

The vehicle 100 may include a sensor unit 104, a manipulating unit 106, a display 108, a load device 114, and a transceiver unit 112.

The sensor unit 104 may be equipped with various types of detectors for detecting various states and situations occurring in the external environment, internal system, user manipulation, and boarding space of the vehicle 100.

Specifically, the sensor unit 104 may be equipped with an externally facing camera or camera sensor 104a, a light detection and ranging (LiDAR) sensor 104b, a radar sensor 104c, and the like to recognize dynamic and static objects present outside the vehicle 100. The camera 104a may recognize external objects as images during use of the vehicle 100 to generate image data and may transmit the image data to the processor 122. The LiDAR sensor 104b may generate point cloud data as recognized data of an external object and transmit the point cloud data to the processor 122 to generate three-dimensional spatial information that identifies at least the shape of the external object. The radar sensor 104c may generate radar data through radio waves reflected from an external object by emitting radio waves of a specific frequency to surroundings of the vehicle 100 to identify the presence of an external object and the relative distance, speed, direction, and the like of the external object. In the present disclosure, a mounted LiDAR sensor 104b is exemplified, but in other examples, the LiDAR sensor 104b may not be mounted.

The sensor unit 104 may further include a brake sensor 104d, a wheel sensor 104e, and a posture sensor 104f. The brake sensor 104d outputs a braking force or energy value applied to a brake pedal, and the like, and may be, for example, a brake position sensor (BPS) sensor. The wheel sensor 104e may detect a wheel speed, a wheel rotation angle, a wheel rotation angular velocity, and the like of the wheel. The posture sensor 104f may detect the three-axis status of the vehicle 100, such as a yaw, a pitch, and a roll, and output various posture statuses of the vehicle 100 based on the above-described parameters. The posture sensor 104f may include, for example, an inertial measurement unit (IMU) sensor, a gyro sensor, and the like. In addition, the sensor unit 104 may include a positioning sensor for confirming the vehicle's own location. The present disclosure mainly illustrates the sensors of the sensor unit 104 referred to in the description of the embodiment, and sensors that detect various situations not listed herein may be additionally included.

The manipulating unit 106 may comprise a module for the user to manipulate driving. For example, the manipulating unit 106 may be a steering wheel for manual driving, an automatic or manual transmission actuator, an accelerator pedal, a brake pedal, a gear shift, and the like. The gear shift receives control instructions related to the driving direction and stopping of the vehicle 100 and may provide the user with selection authority for the control instructions, classified as, for example, P (stop or park), D (forward driving), R (reverse driving), and N (neutral). The manipulating unit 106 may further have an interface for using, releasing, and selecting detailed functions of an autonomous driving mode requested by the user so that the user may use the autonomous driving function. The manipulating unit 106 may be configured as a hard type interface provided at a predetermined location inside the vehicle 100, or the manipulating unit 106 may be configured as a soft type interface that may be touched on the display 108, for example, to receive various requests related to autonomous driving.

The display 108 may function as a user interface. The display 108 may display, by the processor 122, the operation status, control status, route/traffic information, energy remaining information, content requested by the driver, and the like of the vehicle 100. In addition, the display 108 is configured as a touch screen capable of detecting driver input and may receive a driver's request directed to the processor 122.

The load device 114 is mounted on the vehicle 100 and may be a type of non-driving electric device excluding a driving power system, such as a wheel drive unit 118. The load device 114 is an auxiliary device that receives power from the energy generation unit 110 and may be, for example, an air conditioning system, a lighting system, a seat system, and various devices installed in or on the vehicle 100.

The transceiver unit 112 (e.g., a transceiver) may support mutual communication with the server 200, the ITS device 300, and nearby vehicles 400. The transceiver unit 112 may include a module that processes, for example, cellular communication, WAVE, DSRC communication, and the like. In the present disclosure, the transceiver unit 112 may transmit data generated or stored during driving to the server 200 and may receive data and software modules transmitted from the server 200. The transceiver unit 112 may also support communication with an electronic device carried by a passenger inside the vehicle 100. In the present disclosure, the vehicle 100 may transmit and receive data utilized in the method according to the present disclosure with the outside through the transceiver unit 112.

In addition, the vehicle 100 may include an energy generating unit 110 and an actuating unit 116.

The energy generating unit 110 may generate and supply power and electric power used in a driving power system, such as the actuating unit 116, and a non-driving power system. The non-driving power system may include, for example, the sensor unit 104, the manipulating unit 106, the display 108, the load device 114, and the transceiver unit 112 and may include various components that implement sensing, interface, communication, and convenience functions, excluding components directly involved in the driving operation, without being limited thereto. When the vehicle 100 is driven based on electric energy, the energy generating unit 110 may be configured as, for example, an electric battery that is charged from the outside, or a combination of an electric battery and a fuel cell that charges the battery. In the case of a combination of an electric battery and a fuel cell, the energy generating unit 110 may include a tank that stores a material used to produce power from the fuel cell, such as liquefied hydrogen. In the case of a vehicle 100 driven by fossil energy, the energy generating unit 110 may be configured as an internal combustion engine. In addition, in the case of a vehicle 100 of a hybrid type, the energy generating unit 110 may be provided as a combination of an internal combustion engine and an electric battery.

The actuating unit 116 has at least one module that implements a driving operation and may perform at least one driving operation among longitudinal control, such as acceleration/deceleration, lateral control such as steering, and gear shifting according to a user request from the manipulating unit 106 or a request from the processor 122. In this example, the gear shifting may be processed by a manual driving user using a gear shift or by a request from the processor 122 in autonomous driving. Gear shifting is a control instruction related to the driving direction and stopping of the vehicle 100 and may be control instructions classified as, for example, P (stop or park), D (forward driving), R (reverse driving), and N (neutral).

The actuating unit 116 may be equipped with a wheel driving unit 118, a mechanical component, and an electronic module configured to implement a driving operation in the wheel driving unit 118, in order to perform a driving operation according to a user's manual operation or a command of the processor 122 by autonomous driving. When the vehicle 100 is operated based on electric energy, the actuating unit 116 may include an assembly for transmitting a requested driving operation to the wheel driving unit 118. When the vehicle 100 is operated based on fossil energy, the actuating unit 116 may be equipped with a transmission and a gear module for transmitting the power of an internal combustion engine.

The wheel drive unit 118 may include a plurality of wheels, a driving force generation module for generating driving force and applying or transmitting driving force to the wheels, a braking module for decelerating the driving of the wheels, and a steering module for realizing lateral control of the wheels. When the vehicle 100 is driven based on electric energy, the driving force generation module may be configured as a motor assembly for generating driving force based on power output from an electric battery. The braking module of the electric-based vehicle 100 may further have a regenerative braking function.

In addition, the vehicle 100 may include a memory 120 and a processor 122.

The memory 120 may store an application and various data for controlling the vehicle 100 and may load the application or read or write the data upon request of the processor 122. In the present disclosure, the memory 120 may store an application for acquiring training data and at least one instruction for a driving assistance model, i.e., an embodiment according to the present disclosure. The application may acquire sensor data selected as training data based on vehicle data output from the sensor unit 104 and the processor 122 among image data acquired by the camera 104a and may transmit the sensor data to the server 200.

In addition, the memory 120 may be equipped with a driving assistance model configured as an artificial intelligence network to implement the autonomous driving function of the vehicle 100. The driving assistance model may be a deep learning-based network that supports or controls autonomous driving in road driving and various specific driving situations. The specific driving situations may include a situation according to autonomous parking driving, and the driving assistance model for implementing autonomous parking may include a surrounding environment prediction model utilized in autonomous parking driving. The surrounding environment prediction model may be a model that identifies nearby objects of the vehicle 100 by sensor data acquired from the vehicle 100, such as image data, and predicts the behavior of the vehicle 100 due to the nearby objects. In order to improve the autonomous driving function, the vehicle 100 may receive update information of the model distributed from the server 200, for example, update information on learnable parameters of the model, and update the driving assistance model managed in the memory 120 using the update information.

The processor 122 may perform overall control of the vehicle 100. The processor 122 may be configured to execute applications and instructions stored in the memory 120. The processor 122 may generate control instructions for components of the vehicle 100 according to driving control requests in manual driving and autonomous driving. The components may be at least one of the various members or components described in FIG. 2. For example, the processor 122 may generate gear shift data including control instructions related to driving directions and stopping and may transmit the gear shift data to the actuating unit 116 so that the actuating unit 116 may control the autonomous driving according to various driving situations.

The processor 122 may execute processing to acquire vehicle data including at least one of a status of components of the vehicle 100 occurring during driving, a control instruction for the components, or image data for detecting the surrounding environment from the camera 104a. The status of a component of the vehicle 100 is state data of the component detected by the sensor unit 104, and the component may include at least one of the members or components of the vehicle 100 described above in FIG. 2. The processor 122 may perform processing to generate behavior information of the vehicle 100 based on the motion of the vehicle 100 estimated from the vehicle data. The processor 122 may perform processing to acquire image data of the vehicle 100 related to behavior information that matches a target behavior as training data of the driving assistance model. Details related to the above-described processing are described below.

The processor 122 is illustrated as a single processing module, as in FIG. 2, to execute the above-described processing. Specifically, the processor 122 may be equipped with an electronic control unit (ECU) that performs at least a part of the above-described processing. As another example, the processor 122 may include a plurality of processing modules, and the above-described processing may be distributed and processed in the plurality of modules.

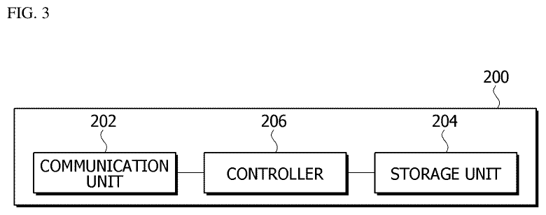

FIG. 3 is a diagram illustrating modules that constitute a server according to another embodiment of the present disclosure.

In the present disclosure, an electronic device that executes a request for use of a point of interest using waiting time prediction may be exemplified as a server 200 that communicates with a vehicle 100.

The server 200 may train or update a driving assistance model based on training data including at least image data received from the vehicle 100 and may transmit the model or update information of the model to the vehicle 100.

The server 200 may include a communication unit 202, a storage unit 204, and a controller 206.

The communication unit 202 may transmit and receive data with an external device, may support mutual communication with the vehicle 100 in the present disclosure, and may exchange data with the vehicle 100.

The storage 204 may store an application and various data for operating the server 200 and may load an application or read or write data upon a request from the controller 206. In the present disclosure, the storage 204 may manage the driving assistance model built into the vehicle 100. When the driving assistance model is an artificial intelligence network, the storage 204 may hold the parameters of the model and store update information resulting from relearning of the model.

The controller 206 may perform overall control on the server 200. The server 200 may be configured to execute applications and instructions stored in the storage 204. The controller 206 may execute the application, and process and respond to a user's request transmitted from the vehicle 100. In relation to the present disclosure, the controller 206 may analyze training data including at least image data received from the vehicle 100 and may analyze and/or tag additional information related to a target situation to training data that matches the target situation and may determine the tagged training data as the final training data. The controller 206 may train or update the driving assistance model using the final training data and may transmit the model or update information of the model to the vehicle 100. As another example, the controller 206 may receive image data and vehicle data from the vehicle 100 to generate behavior information of the vehicle 100, select image data related to behavior information that matches a target behavior, and select the image data as training data.

In the present disclosure, the controller 206 may include a single processing module. As another example, the controller 206 may be distributed as a plurality of processing modules, allowing the above-described processing to be executed by the distributed processing models.

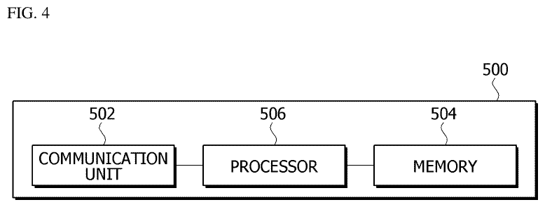

FIG. 4 is a drawing illustrating an apparatus for generating training data according to an embodiment.

Referring to FIG. 4, a configuration included in an apparatus 500 for generating training data according to an embodiment of the present disclosure may be identified. The apparatus 500 for generating training data may be a configuration included in the vehicle 100 or the server 200. Alternatively, the apparatus 500 for generating training data may correspond to a device provided separately from the vehicle 100 or the server 200.

The apparatus 500 for generating training data may include a processor 506, a memory 504, and a communication unit 502. The memory 504 may store data sensed by the sensor unit 104. The camera sensor 104a may generate image data. The LiDAR sensor 104b may generate point data. The apparatus 500 for generating training data according to the present disclosure provides a technology with which an object located at a distance can be identified through image data and point data collected through the camera sensor 104a and the LiDAR sensor 104b.

As the sensor utilized by the apparatus 500 for generating training data, a camera sensor 104a and a LiDAR sensor 104b are disclosed, but the present disclosure may include other sensors. For example, it is also possible to utilize data sensed through a radar sensor (such as radar sensor 104c) instead of the LiDAR sensor 104b. However, the following description is made based on data collected through the camera sensor 104a and the LiDAR sensor 104b.

The processor 506 may identify an object located at a distance by processing image data and point data stored in the memory 504. The processor 506 may include an image processing unit that processes image data and a point processing unit that processes point data. The image processing unit and the point processing unit may process image data and point data, respectively, to generate object information of an object located at a distance.

Because the object information is generated based on two individual pieces of data, there is a need for a process of matching the object information. The processor 506 may include a matching unit that matches the object information. The matching unit matches the object information generated by the image processing unit with the object information generated by the point processing unit. Matching the object information may be considered as determining the same object in each piece of data.

The apparatus 500 for generating training data may further include a communication unit 502.

The communication unit 502 is a configuration that may communicate with an external device or a server 200 of the apparatus 500 for generating training data. The communication unit 502 may receive data such as image data, point data, and the like. The received data may be stored in the memory 504. When the training data is generated through the processor 506, the training data may be exported to the outside of the apparatus through the communication unit 502.

It is not easy to recognize an object located at a distance from image data and point data.

In the case of image data collected through the camera sensor 104a, objects located at a distance are displayed relatively small, and it may be difficult to recognize information such as the shape and boundary of the object due to the resolution of the image. The camera sensor 104a has its own focal length and resolution, making it difficult to focus on objects located at a distance. Additionally, distant objects appear small, making it difficult for the object recognition network to recognize the objects.

In the case of point data collected through a LiDAR sensor 104b, objects located at a distance may have sparse points generated thereon. The LiDAR sensor 104b may emit laser light in a radial direction and may measure the arrival time of light reflected from the object. Through this process, 3D location information is acquired in the form of a point group, i.e., a point cloud. When the laser light is emitted radially while rotating at a predetermined angle, objects located at a distance may have relatively few points generated thereon. In other words, few points for recognizing the object are generated, making it difficult to recognize the object.

The present disclosure may improve the accuracy of object recognition by recognizing an object located at a distance from image data and point data, generating object information from each type of data, and then matching the object information

In the case of point data, because three-dimensional (3D) position information of the points is acquired, a distant object can be distinguished (detected) based on the position of the distant object. In the case of image data, separate 3D position information may not be acquired. The present disclosure may distinguish/detect a distant object based on the characteristic that a distant object in image data is located adjacent to a vanishing point (VP) identified in the image.

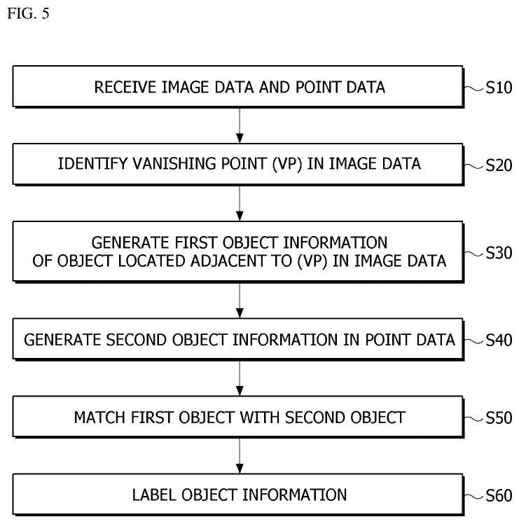

FIG. 5 is a flowchart illustrating a method of generating training data according to an embodiment of the present disclosure.

Referring to FIG. 5, the entire flow of the method of generating training data according to an embodiment of the present disclosure may be confirmed.

First, an operation (S10) of receiving image data and point data through a camera sensor 104a and a LiDAR sensor 104b is performed. The input data may be stored in a memory 504. Thereafter, a process of processing the image data and the point data may be performed. The process of processing the image data may include an operation (S20) of identifying a VP in the image data and an operation (S30) of generating object information of a first object located adjacent to the VP. An operation of processing the point data may include an operation (S40) of generating second object information in the point data.

The process of processing the image data and the point data may be separately performed. The process of processing the image data may be performed by an image processing unit. The process of processing the point data may be performed by a point processing unit.

After the first object information and the second object information are generated from the image data and the point data, respectively, an operation (S50) of matching the first object with the second object may be performed. This operation may be performed by a matching unit. The matching unit may receive the processed image data and the processed point data and match the first object with the second object.

The first object information and the second object information may be generated in the form of a bounding box. The bounding box may include three-dimensional position information of the object. The matching unit may determine the identity of the first object and the second object by matching the bounding boxes to each other. In the following description, the first object information and the second object information are described based on the first bounding box 700 and the second bounding box 800. However, the first object information and the second object information are not limited to the bounding boxes and may include other forms of information.

After the matching of the first object and the second object, an operation (S60) of labeling object information in the image data may be performed. When the first object and the second object are matched, the first object and the second object are determined to be the same object. The first object information and the second object information contain information about the same object. A process of synthesizing the information and labeling the corresponding object in the image data may be performed.

The specific details of each operation are described below.

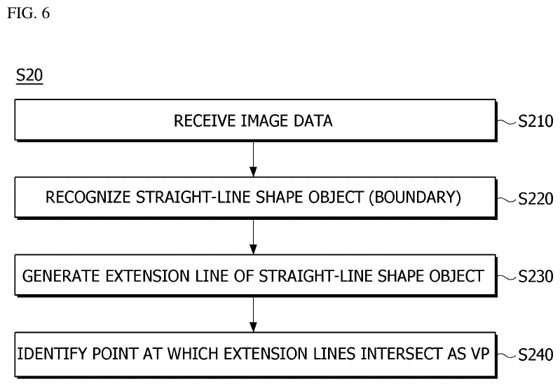

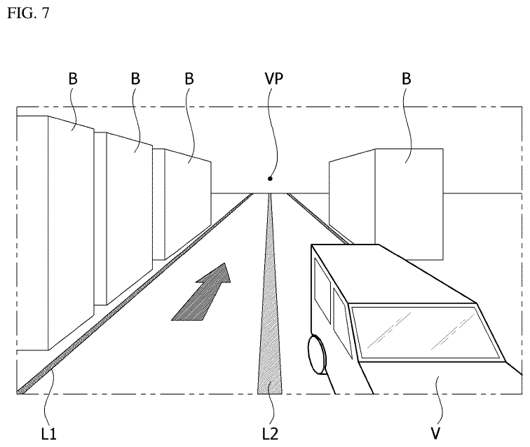

FIG. 6 is a flowchart illustrating a vanishing point identification method according to an embodiment, and FIG. 7 is a diagram illustrating a vanishing point identified in image data according to an embodiment.

Referring to FIG. 6, an operation for identifying a VP in image data may include an operation (S210) of receiving image data, an operation (S220) of recognizing a straight-line shape object in the image data, an operation (S230) of generating an extension line of the straight-line shape object, and an operation (S240) of identifying a point at which the extension lines intersect as a VP.

A VP is a virtual point at which parallel lines in a three-dimensional space appear to converge and meet at a single point according to perspective when projected on a two-dimensional image. A space imaged by the camera sensor 104a corresponds to three dimensions, but in a process of projecting the space onto a two-dimensional image, a virtual VP may be formed.

A VP corresponds to a point at which parallel lines in a three-dimensional space converge, and a point at which parallel lines converge in image data may be identified as a VP. Parallel lines may be formed based on a straight-line object. For example, when acquiring road image data through a camera sensor 104a with which the vehicle 100 in motion is equipped, each lane is formed parallel in a three-dimensional space. Alternatively, at least a portion of a boundary line of the vehicle 100 in motion may be formed parallel. In the case of a building close to a rectangular prism, boundary lines of the building may form parallel lines in a three-dimensional space.

When a straight-line object is recognized in image data and an extension line of the object or the boundary line of the object is extended, the straight lines may converge at one point. The point may be identified as a VP. Identifying a VP in image data may be performed by the image processing unit

When a VP is identified in the image data, the part in which the VP is located may be considered a distant area. For a VP to appear in an image, the field of view may extend to a distant area in the image. At least one VP may be identified in the image data. A plurality of VPs may be present. In other words, multiple distant areas may exist in the image data.

Referring to FIG. 7, a VP may be identified through a lane, a vehicle, and a building. The image data shown in FIG. 7 may be acquired from a camera sensor 104a with which a vehicle 100 driving on a road is equipped.

In FIG. 7, it can be seen that road boundary lines L1 are located at both ends of a road on which a vehicle is driving, and a center lane L2 is located in the center of the road. The road boundary line L1 and the center lane L2 may converge at one point when extended along the length thereof. This point corresponds to a VP.

A vehicle V is located on the road. At least some of the boundaries of the vehicle V may form parallel lines in three-dimensional space. In the image data, the boundaries of the vehicle V extended along the longitudinal direction converge at the VP.

A building B is placed in a part adjacent to the road. At least some of the boundaries of the building B may form parallel lines in three-dimensional space. In the image data, an upper boundary line and a lower boundary line of the building B converge at the VP when extended along the longitudinal direction.

The image processing unit may recognize a straight-line object in the image data. The straight-line object may include the lanes L1 and L2, the median strip, the building B, or the vehicle V as described above. The image processing unit may identify the VP by extending the lines of the straight-line object or the boundary line of the object.

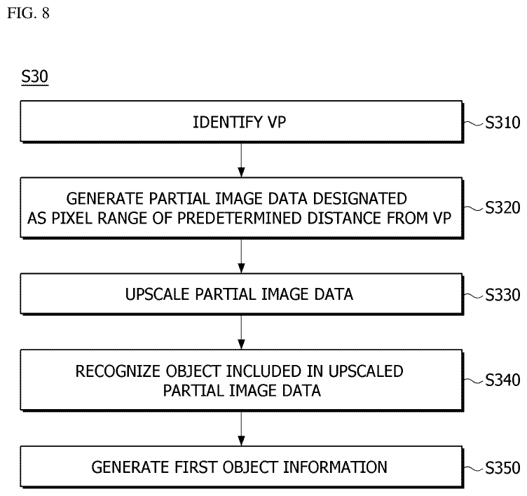

FIG. 8 is a flowchart illustrating a method of generating first object information according to an embodiment.

After the operation (S310) of identifying a VP in image data is performed, an operation of generating object information of a first object located adjacent to the VP may be performed. The method of generating object information of the first object is illustrated in FIG. 8 in detail. In other words, the method illustrated in FIG. 8 corresponds to operation S30 of FIG. 5.

An object recognized in the image data corresponds to the first object. The image processing unit may generate object information of the first object. The method of generating the object information of the first object may include an operation (S320) of generating partial image data 600 designated as a pixel range of a predetermined distance from the VP, an operation (S330) of upscaling the partial image data 600, an operation (S340) of recognizing a first object included in the upscaled partial image data 600, and an operation (S350) of generating first object information.

An area adjacent to the VP in the image data corresponds to a distant area. Therefore, an object adjacent to the VP may be considered an object located at a distance. The image processing unit may classify an object located adjacent to the VP as a distant object.

However, it is difficult to recognize a first object located at a distance in the image data due to the limitations of the resolution and image quality of the image data. Therefore, the first object may be recognized by upscaling at least a part of the image data.

Upscaling is a technique for enlarging at least a part of the image data and improving the resolution or image quality of the enlarged part. For example, the resolution and image quality may be improved by filling in pixels in an area of the enlarged image data that is formed during the enlargement process. The filled pixels may correspond to the colors of adjacent surrounding pixels.

The image processing unit may generate partial image data 600 designated as a pixel range at a predetermined distance from the VP. The partial image data 600 includes an area surrounding the VP and corresponds to a distant area. The partial image data 600 may be upscaled. When the partial image data 600 is enlarged, the partial image data 600 may be enlarged at a preset designated ratio. In other words, the partial image data 600 may be enlarged at a designated ratio, and then the resolution and image quality of the partial image data 600 may be improved.

The upscaled partial image data 600 corresponds to data that allows an object to be recognized by the image processing unit. The image processing unit may recognize a first object included in the partial image data 600.

After the first object is recognized, first object information may be generated. The first object information may include three-dimensional position information of the first object. In the present embodiment, the first object information is set in the form of a bounding box. The bounding box corresponds to a box surrounding a specific object. The bounding box including three-dimensional position information is formed in a rectangular prism shape and surrounds the specific object.

The first object information may include a first bounding box 700 including three-dimensional position information. The first object information may be generated through a three-dimensional (3D) recognition network. The 3D recognition network corresponds to a network that generates 3D position information of an object recognized from 2D image data. The image processing unit may process the partial image data 600 through the 3D recognition network to generate first object information.

The first object information includes 3D position information of the first object and may include specifications including the width and height of the first object and distance information to the first object. However, because the first object is recognized based on the upscaled partial image data 600, the distance information to the corresponding object may be subject to an operation of adjustment according to the enlargement ratio.

The distance information to the first object may be recognized as a close distance in inverse proportion to the designated enlargement ratio of the partial image data 600. As an example, assume that the actual distance to the first object included in the partial image data 600 is 200 meters. When the partial image data 600 including the first object is upscaled by a factor of 4, the distance to the first object may be recognized as 50 meters. Therefore, a process of correcting the distance to the first object is required.

When the first object information is generated through the 3D recognition network, and the like, 3D position information may be adjusted inversely proportional to the designated ratio. The adjusted 3D position information corresponds to the final first object information. The first object information of the first object present in the distant area in the image data is generated through the above process.

When estimating 3D position information of an object in 2D image data, extrinsic parameters of the camera sensor 104a may be utilized. The extrinsic parameters include the position/coordinates of the camera sensor 104a and the rotation direction/heading angle of the camera. When the extrinsic parameters of the camera sensor 104a are reflected in the 2D image, the 3D position information of the object present in the image data may be estimated.

Accordingly, the first object information generated through the 3D recognition network may also be corrected based on the extrinsic parameters of the camera. After the operation of processing the partial image data 600 through the 3D recognition network to generate 3D position information, an operation of correcting the 3D position information based on the extrinsic parameters of the camera sensor 104a may be performed, and the first object information may be generated.

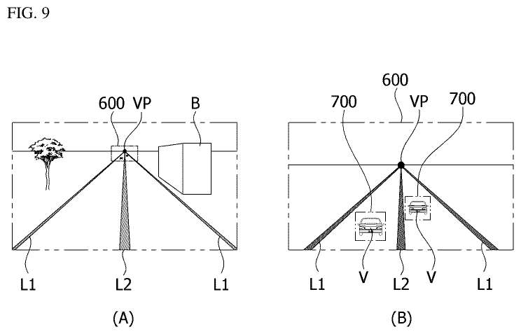

FIGS. 9A and 9B are drawings illustrating a portion of image data being upscaled according to an embodiment.

Referring to FIG. 9A, a VP is identified at the center of the image data. A range of a predetermined distance from the VP may be designated as partial image data 600. The predetermined distance may be designated as the number of pixels. Before upscaling, an object included in the partial image data 600 is not easily recognized. In the embodiment, the partial image data 600 is designated as a rectangular box. The partial image data 600 in the embodiment is formed as a rectangle, but the partial image data 600 may also be formed as another shape, such as a circle.

FIG. 9B illustrates upscaled partial image data 600. The partial image data 600 may be enlarged at a designated ratio. The enlarged partial image data 600 may be upscaled to provide a clearer resolution or image quality. The first object included in the partial image data 600 is identifiable.

Recognition of the first object and generation of the first object information are performed in a state in which the partial image data 600 is upscaled as shown in FIG. 9B. Referring to FIG. 9B, a VP is located at the center of the partial image data 600. The area surrounded by the rectangular box shown in FIG. 9B corresponds to the partial image data 600. The area outside of the partial image data 600 in the image data may be cropped. In other words, the outside area is cut off, leaving only the partial image data 600 detected, which is then enlarged.

An object located at a distance may appear in the partial image data 600. The partial image data 600 that is simply enlarged is not easily identifiable. Therefore, the image quality or resolution of the partial image data 600 may be improved through the upscaling process. Referring to FIG. 9B, the partial image data 600 with improved image quality or resolution is illustrated. The shape of a vehicle V located at a distance is specifically displayed in FIG. 9B. The upscaled partial image data 600 corresponds to a state in which object recognition is facilitated.

A box displayed in the partial image data 600 of FIG. 9B may correspond to a bounding box 700 for the identified vehicle V. Two vehicles V that were not detected in a previous state in FIG. 9A may be detected after upscaling as in FIG. 9B.

The 3D recognition network may recognize an object in the partial image data 600 upscaled to the state of FIG. 9B. Through this, first object information including 3D location information may be generated. The object displayed in the enlarged partial image data 600 may be recognized as being closer than the actual location. Therefore, the location information may be adjusted inversely to the designated ratio, which is the upscaling ratio.

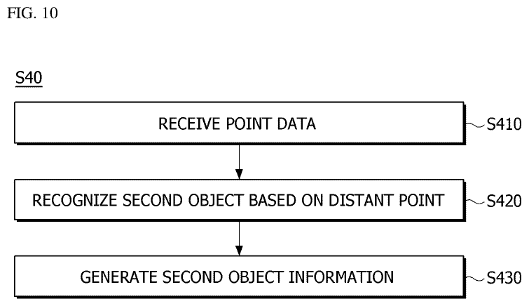

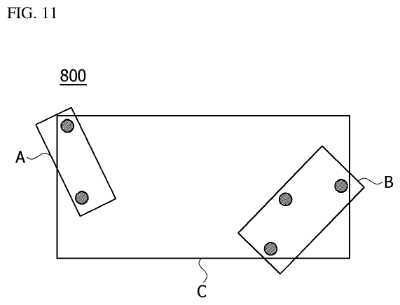

FIG. 10 is a flowchart illustrating a method of generating second object information according to an embodiment, and FIG. 11 is a diagram illustrating a second bounding box including a candidate box according to an embodiment.

Referring to FIG. 10, a method of generating second object information may include an operation (S410) of receiving point data, an operation (S420) of recognizing a second object based on a distant point, and an operation (S430) of generating second object information.

Point data collected through a LiDAR sensor 104b is collected in the form of a point cloud. In other words, points are generated on an object in a three-dimensional space, and the object may be recognized. However, in the case of a distant object, the number of points generated on the object is small, and the interval between points is wide, making it difficult to recognize the specific shape of the object.

Because the point data includes location information in points generated in a three-dimensional space, the second object may be recognized based on points generated in a distant area. In this case, recognizing the second object may be understood as recognizing a candidate group of the second object. The second object information may include a second bounding box 800 that includes three-dimensional (3D) position information of the second object.

Because it is difficult to specifically recognize the shape of the second object, a candidate group estimated to be the second object may be recognized based on a point cluster located at a specific distance. In other words, this process means recognizing the candidate group of the second object as described above. The point processing unit may generate a candidate box of the second object that may be derived based on the position of the point. The second bounding box 800 may include a plurality of candidate boxes. The second bounding box 800 may correspond to a cluster of a plurality of candidate boxes. Generating the second bounding box 800 may mean generating a plurality of candidate boxes that are likely to be recognized as the second object.

FIG. 11 illustrates a second bounding box 800 being processed. FIG. 11 illustrates point data generated in a three-dimensional space. FIG. 11 illustrates point data viewed from the height direction of the three-dimensional space.

Referring to FIG. 11, a total of five pieces of point data are illustrated. Of the five pieces of point data, two points located on the left and three points located on the right are located adjacent to each other. Therefore, the two points located on the left may be recognized as a second object, and the three points located on the right may be recognized as another second object. In other words, they may be recognized as two separate objects. In contrast, all of the five points may be recognized as representing a single second object.

When generating a second bounding box 800 based on the point data illustrated in FIG. 11, three candidate boxes A, B, and C may be formed. Candidate box A and candidate box B may be formed to enclose the two-point cluster located on the left and the three-point cluster located on the right, respectively. Candidate box C, on the other hand, may be formed to enclose all five points. Because it is not easy to recognize a second object located at a distance, the second bounding box 800 may be formed to include a plurality of candidate boxes that are likely to be recognized as the second object.

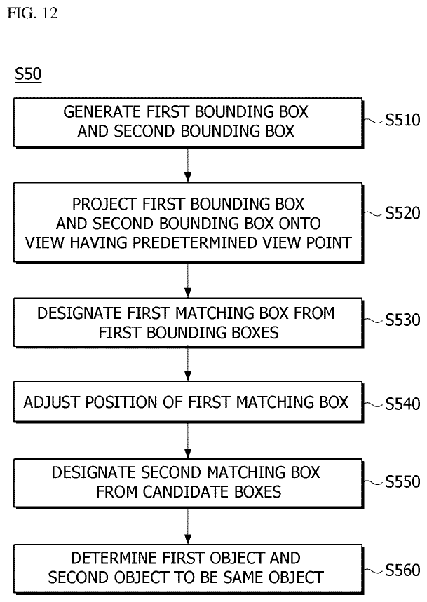

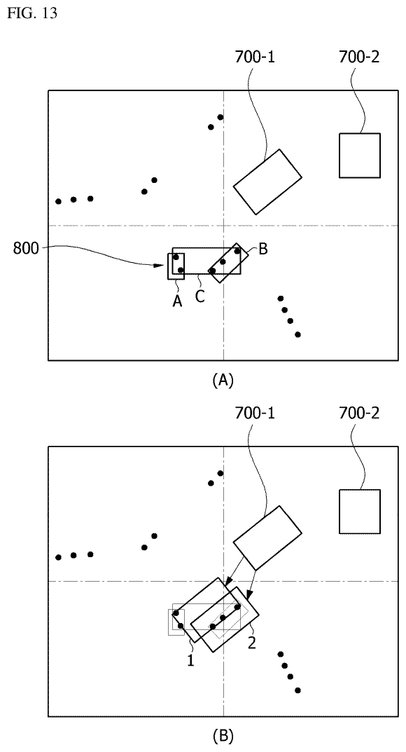

FIG. 12 is a flowchart illustrating a method of matching a first object with a second object according to an embodiment. FIG. 13 is a drawing illustrating matching of a first matching box with a second matching box according to an embodiment.

Referring to FIG. 12, a method of matching a first object with a second object may include an operation (510) of generating a first bounding box and a second bounding box, an operation (520) of projecting the first bounding box and the second bounding box onto a view having a predetermined view point, an operation (S530) of designating a first matching box from first bounding boxes 700 based on a distance and morphological similarity with second bounding boxes 800, an operation (S540) of adjusting a position of the first matching box, an operation (S550) of designating a second matching box from candidate boxes based on the degree of overlap with the first matching box and the number of overlapping points with the first matching box, and an operation (S560) of determining that a first object included in the first matching box and a second object included in the second matching box are the same object.

The first object information or the first bounding box 700 is information generated based on an object recognized from image data. The second object information or the second bounding box 800 is information generated based on an object recognized from point data. In order to match the first object and the second object recognized through different data, the operation (S520) of projecting the two pieces of data onto the same coordinate system may be included.

Therefore, after the first bounding box (or boxes) 700 and the second bounding box (or boxes) 800 are generated, the first bounding box(es) 700 and the second bounding box(es) 800 may be projected to a view having a predetermined viewpoint. The view may be, for example, a view having a viewpoint in the height direction of the first bounding box(es) 700 and the second bounding box(es) 800. In other words, it may be the same view as a bird's eye view. Alternatively, it is also possible to project the first bounding box(es) 700 and the second bounding box(es) 800 to the same coordinate system based on the same view having the predetermined viewpoint.

When the first bounding box 700 and the second bounding box 800 are projected based on the same coordinate system, the first bounding box 700 and the second bounding box 800 may be matched. In this example, matching corresponds to a process of identifying bounding boxes for the same object among a plurality of first bounding boxes 700 and a plurality of second bounding boxes 800.

Image data and point data correspond to data collected through different sensors, and the image data and the point data are subjected to separate processing to generate three-dimensional position information of objects. Therefore, even when the first object information and the second object information generated from the two types of data are based on the same object, a certain error may occur. Even when the first object information and the second object information are projected onto the same coordinate system, the first object information and the second object information may include a certain difference. Therefore, a process of correcting the error or difference may be performed.

The matching unit may designate a first matching box among the first bounding boxes 700 based on a specific second bounding box 800. The second bounding box 800 may include a plurality of candidate boxes, and the first matching box may be designated based on the distance and morphological similarity with the plurality of candidate boxes. The first matching box may correspond to a bounding box positioned at the closest distance to the specific second bounding box 800 and having a similar shape to the specific second bounding box 800.

When the first matching box is designated, the position of the first matching box may be adjusted. Because point data provides relatively accurate position information in three dimensions, the position of the first matching box may be adjusted based on the second bounding box 800. The position of the first matching box may be adjusted to overlap the second bounding box 800. The position of the first matching box may be adjusted to a position at which the degree of overlap and the number of overlapping points are maximum within the range in which the first matching box overlaps the second bounding box 800.

The first matching box may have the position adjusted and the matching suitability with a plurality of candidate boxes included in the second bounding box 800 may be determined. A candidate box with the highest matching suitability may be designated as the second matching box. The matching suitability may be calculated based on the degree of overlap with the candidate box and the number of overlapping points with the candidate box. The matching unit calculates the matching suitability of each candidate box according to the position of the first matching box, detects a candidate box with the maximum matching suitability and designates the candidate box as the second matching box.

The degree of overlap is a parameter determined by comparing the size of an overlapping area of two bounding boxes with the size of the total area. The degree of overlap corresponds to the intersection over union (IoU), which is a value obtained by dividing the area of the overlapping area of the two bounding boxes by the sum of the total areas of the two bounding boxes. The number of overlapping points may be the number of points simultaneously included in the two bounding boxes. The matching unit may calculate the matching suitability by reflecting both the degree of overlap and the number of overlapping points and may designate the second matching box.

The parameters reflected in the matching suitability may include other parameters in addition to the degree of overlap or the number of overlapping points. For example, the parameters may include the distance or morphological similarity with the first matching box. The matching unit may match a pair of bounding boxes that are most likely to represent the same object by comprehensively considering various parameters.

When the first matching box and the second matching box are designated, the first object and the second object included in the first matching box and the second matching box are determined to be the same object. The three-dimensional position information of the object included in the first matching box and the second matching box may be determined to represent position information of the same object.

FIGS. 13A and 13B are drawings illustrating a first matching box and a second matching box being matched according to an embodiment. FIG. 13A illustrates a state in which the first bounding box(es) 700 and the second bounding box(es) 800 are projected to the same view. Two first bounding boxes 700-1 and 700-2 are illustrated. A second object candidate cluster of point data includes three candidate boxes A, B, and C. In other words, the second bounding box 800 includes three candidate boxes.

The matching unit may designate a first matching box among the first bounding boxes 700 as a matching target based on the distance and morphological similarity with the second bounding box 800. In FIG. 13A, a first bounding box 700-1 located on the left corresponds to the first matching box.

FIG. 13B illustrates the position of the first matching box being adjusted. The first matching box 700-1 is positioned to correspond to the second bounding box 800. The matching unit designates the second matching box from the candidate boxes A, B, and C included in the second bounding box 800 while adjusting the position of the first matching box 700-1.

When the first matching box 700-1 is placed at position 1, it can be seen that the C candidate box has the largest degree of overlap and the largest number of overlapping points. In this case, the C candidate box may be designated as the second matching box. In other words, the objects included in the first matching box 700-1 and the second matching box C are determined to be the same object.

After the matching unit performs the operation (S50) of matching the first object with the second object, an operation (S60) of labeling object information in the image data may be performed. As described above, object information may include a bounding box including three-dimensional position information. Information of the first bounding box 700 and the second bounding box 800 based on the same object may be labeled in the image data.

The above process may be performed by the processor 506. Labeling information in the image data may involve labeling three-dimensional (3D) position information of the first matching box 700-1 and the second matching box C and pixel information of the first object in the image data. In other words, the pixel representing the first object in the image data is matched with the information of the object represented by the pixel.

Before labeling the object information, an operation of verifying the consistency of the matched object information may be included. The matching unit may designate a pair of matching boxes by adjusting the first matching box to designate the second matching box, and then verify whether the matching process is appropriate. The matched pair of matching boxes may be reprojected onto an image to check whether the matching boxes correspond to the object of the image.

The data matched by the matching unit corresponds to three-dimensional position information/a bounding box extracted from the image data and point data. In other words, the matching unit does not directly match the image data with the point data. However, the matching unit matches the object information of the object extracted through the processing of the image data and the point data. Therefore, the information of the matched object may be projected back onto the image data to verify whether the information corresponds to the object displayed in the image.

Although the methods of the present disclosure are presented as a series of operations for clarity of description, this is not intended to limit the order in which the operations are performed, and each operation may be performed simultaneously or in a different order, if desired. In order to implement a method according to the present disclosure, additional steps may be included in addition to the operations illustrated, or some of the operations may be excluded and the remaining steps may be included, or some of the operations may be excluded and other additional steps may be included.

The various embodiments of the present disclosure are not intended to list all possible combinations but rather to illustrate representative aspects of the present disclosure, and the matters described in the various embodiments may be applied independently or in combinations of two or more.

In addition, various embodiments of the present disclosure may be implemented in hardware, firmware, software, or a combination thereof. In the case of hardware implementation, the embodiments may be implemented by one or more application-specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, and the like.

The scope of the present disclosure includes software or machine-executable instructions (e.g., an operating system, an application, firmware, a program, and the like) that cause operations according to the methods of various embodiments to be executed on a device or a computer, and a non-transitory computer-readable medium on which such software or instructions are stored and which is executable on the device or the computer.

As is apparent from the above, according to an embodiment of the present disclosure, partial image data corresponding to a distant area may be generated from image data, and through an upscaling process of the partial image data, a distant object may be identified and object information may be generated. The distance object and the object information may be matched with a distant object recognized from point data and generated object information. Thus, the recognition rate of an object located at a distant location and the accuracy of location information of the object may be increased.

The effects of the present disclosure are not limited to those described above, and other effects that are not described above should be clearly understood by those having ordinary skill in the art from the above detailed description.

What is claimed is:

1. A method of generating training data, the method comprising:
receiving image data and point data through a camera sensor and a light detection and ranging (LiDAR) sensor;
determining a vanishing point in the image data;
generating object information of a first object located adjacent to the vanishing point;
generating object information of a second object identified in the point data;
matching the first object with the second object;
labeling the object information in the image data; and
transmitting a driving assistance model trained based on the labeled object information to a vehicle for autonomous driving of the vehicle, wherein the first object is present in partial image data designated as a predetermined distance range from the vanishing point, and
wherein generating the object information of the first object comprises generating the object information of the first object in a state in which the partial image data is upscaled.

2. The method of claim 1, wherein determining the vanishing point in the image data comprises:
identifying the vanishing point as a point at which extension lines of straight-line shaped objects recognized in the image data intersect.

3. The method of claim 2, wherein a straight-line shaped object of the straight-line shaped objects includes at least one of a lane, a median strip, a building, or a vehicle.

4. The method of claim 1, wherein the object information of the first object includes a first bounding box including three-dimensional (3D) position information of the first object, and
wherein the object information of the second object includes a second bounding box including 3D position information of the second object.

5. The method of claim 4, wherein the first bounding box includes position information adjusted inversely proportional to an upscaling ratio.

6. The method of claim 4, wherein the second bounding box includes a candidate box generated to include at least some of points located at a distance in the point data.

7. The method of claim 6, further comprising:
matching the first bounding box and the second bounding box in a view having a predetermined viewpoint.

8. The method of claim 7, wherein matching the first object and the second object comprises:
designating a first matching box from the first bounding box based on a distance and a morphological similarity with the second bounding box;
adjusting a position of the first matching box based on the second bounding box;
designating a second matching box from candidate boxes based on a degree of overlap with the first matching box and the number of overlapping points with the first matching box; and
determining that the first object included in the first matching box and the second object included in the second matching box are the same object.

9. The method of claim 8, wherein labeling the object information in the image data comprises:
labeling 3D position information of the first matching box and the second matching box and pixel information of the first object in the image data.

10. The method of claim 4, further comprising:
generating the 3D position information of the first object by reflecting extrinsic parameters of the camera sensor.

11. The method of claim 7, wherein the view includes a viewpoint in a height direction of the first bounding box and the second bounding box.

12. The method of claim 8, wherein adjusting the position of the first matching box comprises:
adjusting the position of the first matching box to a position at which points included in the second matching box are maximally included in the first matching box.

13. The method of claim 1, further comprising:
after determining whether the first object and the second object are identical, projecting a first matching box and a second matching box onto an image to determine consistency of the object information of the first object and the object information of the second object.

14. An apparatus for generating training data, the apparatus comprising:
a processor; and
a memory configured to store image data of a camera sensor and point data of a light detection and ranging (LiDAR) sensor,
wherein the processor includes:
an image processing unit configured to generate object information of a first object in the image data;
a point processing unit configured to generate object information of a second object in the point data; and
a matching unit configured to match the object information of the first object and the object information of the second object,
wherein the image processing unit is further configured to determine a vanishing point in the image data,
wherein the first object is present in partial image data designated as a predetermined distance range from the vanishing point, and
wherein the image processing unit is further configured to generate the object information of the first object in a state in which the partial image data is upscaled.

15. The apparatus of claim 14, wherein the image processing unit is configured to determine the vanishing point by identifying a point at which extension lines of straight-line shaped objects recognized in the image data intersect.

16. The apparatus of claim 15, wherein a straight-line shaped object of the straight-line shaped objects includes at least one of a lane, a median strip, a building, or a vehicle.

17. The apparatus of claim 14, wherein the object information of the first object includes a first bounding box including three-dimensional position information of the first object, and
wherein the object information of the second object includes a second bounding box including three-dimensional position information of the second object.

18. The apparatus of claim 17, wherein the second bounding box includes a candidate box generated to include at least some of points located at a distance in the point data.

19. The apparatus of claim 18, wherein the matching unit is further configured to match the first bounding box with the second bounding box in a view having a predetermined viewpoint.

20. The apparatus of claim 17, wherein the first bounding box includes position information adjusted inversely proportional to an upscaling ratio.
